(19) United States
(12) Patent Application Publication
(10) Pub. No.: US 2022/0044341 A1
(43) Pub. Date: Feb. 10, 2022

(54) SYSTEM AND METHOD FOR RAPID EVALUATION OF RAW MATERIAL PRICE RISK MITIGATION CONTRACTS

(71) Applicant: Net Alpha Financial Systems, LLC, Birmingham, MI (US)

(72) Inventors: Rami Mizrahi, Tel Mond (IL); Tamir Shalom, Tel Aviv (IL); Daniel Goland, Pacific Palisades, CA (US); Dekel Yossef, Matan (IL); Eyal Mizrahi, West Bloomfield, MI (US); Dor Tzemach, Givatayim (IL)

(21) Appl. No.: 17/289,691

(22) PCT Filed: Oct. 29, 2019
(86) PCT No.: PCT/US19/58478

§ 371 Date: Apr. 28, 2021

Related U.S. Application Data
(60) Provisional application No. 62/752,029, filed on Oct. 29, 2018.

(51) Int. Cl. G06Q 50/18; G06Q 40/04; G06Q 40/08; G06Q 10/06; G06F 16/23

(52) U.S. Cl. CPC G06Q 50/188; G06Q 40/04; G06F 3/04847; G06Q 10/067; G06F 16/2379; G06Q 40/08

(57) ABSTRACT

A system and method for rapid evaluation of raw material price risk mitigation contracts aided by simulations driven by an end-user's selection of a settlement parameter, which enable transparent and quick evaluations of one or more contracts. The simulations are presented on a user interface that provides for a unique communication of information relevant to the one or more contracts. An end-user's selection of a settlement parameter is enabled by a digital slider, the actuation of which presents updated simulations in substantially real-time.

### FIELD

The present disclosure generally relates to a system and method for evaluating raw material price risk mitigation contracts.

### BACKGROUND

Persons or entities dealing in raw materials (hereinafter, “customers” which can include buyers and sellers) bear price risks (i.e., “exposure”) when buying or selling raw materials. Various instruments are utilized by customers to mitigate pricing risks. Such instruments may be in the form of physical hedging (e.g., purchasing inventory, locking in prices with suppliers and/or with their counterparties), or instruments provided by financial services companies (hereinafter, “financial firms”) that provide financial hedging solutions, trading solutions, or both to customers. One such instrument may be referred to as a raw material price risk mitigation contract (hereinafter, “contract”). The contracts may be entered into by customers and by financial firms in order to protect themselves from market price increases or decreases, depending on their exposure to pricing changes.

Conventionally, customers and financial firms (hereinafter, “transacting parties”) communicate in person or via phone, email, electronic platforms, or instant messaging, in order to negotiate a contract's terms and subsequently to transact in or decline to transact in the contract. Mediums of communication such as these may be prone to inconsistencies. Phone calls and call-backs may be missed, and messages may be queued amidst a long list of other messages concerning various matters. Electronic platforms may allow for collaboration, for offering pricing, and even for execution of contracts, but do not provide tools for rapid evaluation of contract terms. As a result, a considerable amount of time and effort may go into just one contract because of these delays in communication and need for detailed analysis. Furthermore, the more time that passes, the more likely that circumstances, that dictate the terms of a contract, may change (e.g., activities in the raw material's physical market), rendering the contract moot.

Transacting parties' determination of whether to transact in or decline to transact in a contract may require a quick decision, driven by time pressures, or a decision prefaced by careful forethought. Transacting parties make a determination of whether to enter a contract based on a review of the terms of a contract (hereinafter, “contract specifications”), in view of historical pricing data, fundamental data concerning the raw material (e.g., volatility, forward price curves, and supply and demand forecasts), and other market data related to the raw material covered in the contract. This task may involve pulling data, such as price indices, from a variety of data sources and making proprietary or discretionary judgments on the contract based on data that may span as far back as 5 years or perhaps even longer. The complexity of this task is multiplied where the transacting parties are assessing multiple contracts at once.

The contracts may operate generally by obligating the transacting parties to settle the contracts based on a trigger event (e.g., monthly or periodical change in the raw material price; exceeding or falling below a price limit; exceeding or falling below an average price during a period) defined in the contracts. As such, one of the terms of the contract that is important in determining whether to transact in or decline to transact in the contract may be an economic term. Whether an economic term set forth by a contract is acceptable to a transacting party may depend on a probability of a raw material's price, a function of a raw material's prices within a certain time period (e.g., an average of the raw material's prices), and/or reaching a certain economic term defined in the contract specifications. Such a probability is derived primarily from historical data but determining probabilities on one or more projected prices is a time-consuming process.

The time and effort required for communication between transacting parties, the proprietary or discretionary judgments antecedent to the decision whether to transact in the contracts, the derivation of probability associated with the contracts, or any combination thereof, as discussed above, may result in a chilling effect on the transacting of the contracts. As such, transacting parties may forego entering into the contract if communication is drawn out too long, proprietary or discretionary judgments are not supported by confidence, derivation of probability is not supported by confidence, or any combination thereof.

One or both of the transacting parties may transact in more than one contract at the same time. The customer may be transacting in more than one contract with a same financial firm, different financial firms, or both. The financial firm may be transacting in more than one contract with the same customer, different customers, or both. The exposure embodied in each of the various contracts transacted in by the single transacting party may vary from contract to contract. As a consequence, the decision regarding how much exposure should be afforded on a subsequent contract is not clearly ascertainable. Similarly, the decision regarding how much exposure would follow the buying or selling of contracts within a transacting party's portfolio is not clearly ascertainable. This lack of clarity may impede the transacting parties' desire or ability to transact in subsequent contracts.

There is a need for a system and method that provides for a user interface that concisely and efficiently presents the requisite data upon which to make an informed decision to transact in or decline to transact in a raw material price risk mitigation contract in a time effective manner.

There is a need for a system and method to expeditiously compile and display the probability of a price change of a raw material occurring in historical data, the probability of the function of a raw material's prices as determined in the contract occurring in historical data, and what the outcomes of such an occurrence would be on a raw material price risk mitigation contract that is being evaluated.

There is a need for a system and a method to provide a portfolio of contracts in which a transacting party may expeditiously, for all of said contracts in the portfolio, compile and display the probabilities of all price changes of all relevant raw materials occurring in historical data, the probabilities of the functions of all relevant raw material's prices as determined in the contracts occurring in historical data and what the outcomes of such occurrences would be on the portfolio.

There is a need for a system and method that allows a transacting party to expeditiously compile and display one or more contracts being considered to be bought (i.e., not yet in the transacting party's portfolio) against one or more contracts being considered to be sold (i.e., in the transacting party's portfolio) in order to evaluate economic outcomes (e.g., profit, economic spreads) of potential purchases and sales of contracts.

There is a need for a system and method that allows a transacting party to evaluate contract terms and economic terms multiple times (i.e., viewing multiple outcomes produced by various combinations of contract specifications and economic terms), expeditiously, while the transacting parties are negotiating the economic terms of the contracts.

### SUMMARY

The present disclosure relates to a method for mitigating raw material price risks by both a contract buyer and a contract seller through a facilitator comprising: a) providing an end-user with access, via an electronic network, to a user interface, adapted to receive input information from the end-user, the user interface being associated with a computer of the end-user, and wherein the end-user is the contract buyer, the contract seller, or both, b) receiving from the end-user via the electronic network, a first settlement parameter, c) generating a first simulated covered outcome and a first simulated un-covered outcome based upon the first settlement parameter, historical data, contract specifications, and contract variables, d) transmitting the first simulated covered outcome and the first simulated un-covered outcome to the end-user; wherein the step of receiving the first settlement parameter and the step of generating the first simulated covered outcome and the first simulated un-covered outcome are repeated for any number of additional settlement parameters, provided by the end-user to produce any associated number of additional simulated covered outcomes and additional simulated un-covered outcomes; wherein the user interface is adapted to graphically display a selector, the selector having a substantially continuous range of settlement parameters and solicit from the end-user the first settlement parameter and any additional settlement parameters from the substantially continuous range of settlement parameters; and wherein the step of receiving the first settlement parameter and the step of generating the first simulated covered outcome and the first simulated un-covered outcome and any number of subsequent iterations thereof are performed substantially instantaneously, with the aid of the selector, enabling the end-user to explore, visualize, and assess price risks and subsequently communicate feasible contracts to other transacting party before the risk assessment is rendered moot by price risk changes due to market forces, wherein the other transacting party is the contract seller when the end-user is the contract buyer, and the other transacting party is the contract buyer when the end-user is the contract seller.

The present disclosure relates to a method for mitigating raw material price risks by both a contract buyer and a contract seller through a facilitator, comprising: a) accessing, via an electronic network, a user interface, adapted to receive input information from an end-user, the user interface being associated with a computer of the end-user, wherein the end-user is the contract buyer, the contract seller, or both, b) transmitting to the facilitator via the electronic network, a first settlement parameter, c) receiving a first simulated covered outcome and a first simulated un-covered outcome based upon the first settlement parameter, historical data, contract specifications, and contract variables, d) wherein the step of transmitting to the facilitator and the step of receiving a first simulated covered outcome and a first simulated un-covered outcome are repeated for any number of additional settlement parameters; wherein the user interface is adapted to graphically display a selector, the selector having a substantially continuous range of settlement parameters and solicit from the end-user the first settlement parameter and any additional settlement parameters from the substantially continuous range of settlement parameters; and wherein the step of transmitting to the facilitator and the step of receiving a first simulated covered outcome and a first simulated un-covered outcome and any number of subsequent iterations thereof are performed substantially instantaneously, with the aid of the selector, enabling the end-user to explore, visualize, and assess risks and subsequently communicate feasible contracts to other transacting party before the risk assessment is rendered moot by risk changes due to market forces, wherein the transacting party is the contract seller when the end-user is the contract buyer and is the contract buyer when the end-user is the contract seller, wherein the other transacting party is the contract seller when the end-user is the contract buyer, and the other transacting party is the contract buyer when the end-user is the contract seller.

The present disclosure relates to a computer product, comprising a non-transitory computer-usable medium having a computer-readable program code embodied therein, said computer-readable program code containing instructions that when executed by a processor of a computer, implements a method of mitigating raw material price risks for a contract buyer and a contract seller, wherein said method comprises: a) obtaining from an end-user, via an electronic network, a first settlement parameter selected by the end-user through a user interface, wherein the end-user is the contract buyer, the contract seller, or both, b) obtaining historic price data from a dynamic database and generating a graphical display of the historic price data, c) identifying historic trigger events with respect to the first settlement parameter, d) calculating, by at least one processor, a simulated covered outcome and a simulated un-covered outcome based upon the first settlement parameter, historical data, contract specifications, and contract variables, e) transmitting the graphical display of the historic price data, the simulated covered outcome, and the simulated un-covered outcome, via an electronic network, to the end-user; f) wherein steps a through e are repeated for any number of additional settlement parameters chosen by the end-user; wherein the user interface is adapted to graphically display a selector, the selector having a substantially continuous range of settlement parameters and solicit from the end-user the first settlement parameter and any additional settlement parameters from the substantially continuous range of settlement parameters; wherein steps a through e and any number of subsequent iterations thereof are performed substantially instantaneously, with the aid of the selector, enabling the end-user to explore, visualize, and assess risks and subsequently communicate feasible contracts to other transacting party before the risk assessment is rendered moot by risk changes due to market forces, wherein the other transacting party is the contract seller when the end-user is the contract buyer, and the other transacting party is the contract buyer when the end-user is the contract seller.

The present disclosure further relates to a computing device comprising: a) a display screen, b) the computing device being configured to display on the display screen: i) a price limit, fixed price, or both under a contract, ii) a simulated total covered cost, iii) a simulated total un-covered cost, and iv) a substantially continuous range of inputs, selectable by a selector, where the inputs are a simulated price; wherein the simulated total covered cost represents estimated liability of an end-user for purchasing, selling, or both a quantity of a raw material type under a contract having a price limit, fixed price, or both; wherein the simulated total un-covered cost represents estimated liability of the end-user for purchasing, selling, or both a quantity of a raw material type without the contract; wherein selecting from the substantially continuous range of inputs affects the simulated total un-covered cost; and wherein the substantially continuous range of inputs enables the end-user to explore, visualize, and assess risks and subsequently communicate feasible contracts to another transacting party before the risk assessment is rendered moot by risk changes due to market forces.

The present teachings of the disclosure may be advantageous in providing a system and method with a user interface that may be able to concisely and efficiently present the requisite data upon which to make an informed decision to transact in or decline to transact in a contract in a time effective manner. The user interface may enable a substantially real-time visualization of various factors (with associated data) potentially affecting price, a way to toggle through various scenarios while achieving substantially instantaneous output based upon a user-initiated query, or both. Such an approach may be unconventional because there is currently a lack of transparency when evaluating contracts of the present disclosure and determining whether to purchase, approve, or decline a contract of the present disclosure, and where analysis of said contracts may currently be a time-consuming process. The present teachings may be beneficial in providing for a system and method to expeditiously compile and display the probability of a price increase of a raw material occurring in historical data, and what the outcomes of such a price increase would be on a raw material price risk mitigation contract that is being evaluated. The present teachings may be advantageous in enabling a contract buyer, a contract seller, or both to evaluate contracts before the contracts are rendered moot by market forces. The present teachings of the disclosure may be advantageous in providing a unique and unconventional platform and data tools operated by the facilitator, providing transparency to each of the contract seller and contract buyer. As will be seen, use of the unconventional data tool of the present disclosure to transact a contract may function to generate revenue for a contract seller, mitigate risk for a contract buyer, or both (i.e., mutually beneficial).

### BRIEF DESCRIPTION OF DRAWINGS

FIG. 1 illustrates a schematic view of a system as set forth in the present disclosure.

FIG. 2 illustrates a flow diagram of end-users and a facilitator performing the method as set forth in the present disclosure.

FIG. 3 illustrates a user interface.

FIG. 4 illustrates a user interface.

FIG. 5 illustrates a user interface.

FIG. 6 illustrates a user interface.

FIG. 7 illustrates a user interface.

FIG. 8 illustrates a user interface.

FIG. 9 illustrates a user interface.

FIG. 10 illustrates a user interface.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

### A. Introduction

The present disclosure relates, in a very general aspect, to transacting in raw material price risk mitigation contracts between customers and financial firms. As referred to herein, “end-user” may refer to the customer, the financial firm, or both. The “raw materials”, as referred to herein, may include any raw material or agricultural product that can be bought or sold (i.e., economic goods). More specifically, raw materials may include one or more of crude oil, refined energy products, metals, minerals, grains, beans, livestock, monomers, polymers, synthesized chemicals, extracted chemicals, or the like. A customer may be any person or entity purchasing contracts (e.g., “contract buyer,” “buyer”) or selling contracts (e.g., “contract seller,” “seller”) to protect against price increases or decreases in the physical market, which may increase the cost of producing or providing an end product (i.e., comprising one or more raw materials) or service (i.e., requiring one or more raw materials or requiring an end product comprising one or more raw materials), or affect the profit margin of said products or services. These contracts may be considered raw material price risk mitigation contracts. For example, a customer may be an automotive component manufacturer in the business of purchasing iron for the purpose of producing iron castings for automotive components. This automotive component manufacturer may seek to protect itself from price increases in the iron market. As another example, the customer may be a supplier of industrial lubricants in the business of purchasing petrochemicals for the purpose of producing industrial lubricants. This supplier of industrial lubricants may seek to protect itself from price increases in the petrochemicals market. As another example, the customer may be a producer of polyethylene polymer in the business of purchasing ethylene for the purpose of producing polyethylene. This producer of polyethylene polymer may seek to protect itself from price increases in the ethylene market. The same producer may seek to protect itself from future price decreases of polyethylene. Customers may engage in price risk mitigation activities and enter contracts that protect them against raw material price changes. Financial firms may buy contracts, sell contracts, or both. These contracts may cover a customer's raw material price exposures (e.g., for a purpose of obtaining profits therefrom or for the purpose of protecting against raw material price changes).

A financial firm (also referred to herein as a “dealer”) may also buy contracts (e.g., “contract buyer”) to offset the risk taken as a seller of other contracts (e.g., “contract seller”). For example, a financial firm may seek to offset the exposure embodied in a portfolio of contracts the firm is currently transacting in and to do so the firm may buy a contract offering a favorable economic spread (i.e., monetary return on a combination of contracts bought and sold). As used herein, the terms “buyer” and “seller” may refer to a buyer of a contract (e.g., “contract buyer”) and a seller of a contract (e.g., “contract seller”). A customer or a financial firm may act as either the buyer or the seller of the contract.

For purposes herein, “contract” may refer to the ultimate enforceable transaction instrument between a buyer and a seller, or in plural, between buyers and sellers, resulting from the system and method of the present disclosure. It will be seen, as well, that “contract” is used in some instances (e.g., in some of the user interfaces) as a shorthand that describes specified terms of the ultimate transaction document. The term “available contract”, from the perspective of the customer, may refer to contracts, or contract specifications, displayed by the facilitator but yet to be transacted in by a customer; from the perspective of the financial firm, the term may refer to contracts transacted in by a customer but awaiting approval by a financial firm. The term “pending contract”, from the perspective of the financial firm, may refer to contracts yet to be transacted in by a customer (e.g., customer has yet to pay a defined premium to enter the contract).

In one aspect, the present disclosure is directed toward unique transactions for the sale of raw material price risk mitigation contracts. More particularly, the disclosure is directed toward a unique transaction for mitigating risk associated with a dynamic market for a raw material, by which a customer can limit the impact of raw material price changes on its business model (e.g., by guaranteeing profitability, limiting costs of producing a product, limiting loss, or any combination thereof) over a period of time. In doing so, the customer may be able to assure that if a price change arises during that time, the risk of the price change is not entirely upon the customer. The customer may do so by using a new type of platform that provides simplicity, transparency, and accessibility to assess a range of contracts that the customer can select from.

In order to help manage risk, it has been found that transactions of contracts between two or more transacting parties may be facilitated through a facilitator. The facilitator may be any person or entity that provides an application, a system, a method, or any combination thereof providing for a medium for transactions in the contracts. The facilitator may be a neutral facilitator. A neutral facilitator may not be entitled to profit or obligated to loss as a result of the contract outcome (i.e., the occurrence or non-occurrence of a trigger event determined at the time of the contract settlement). The facilitator may favor neither the customer nor the financial firm with respect to transparency in presentation of the contracts and the financial benefit conferred. The facilitator may maintain one or more computers, one or more databases, one or more dynamic databases, or any combination thereof in furtherance of the system, method, or both as described herein. The facilitator may cause a user interface to be displayed on a device (i.e., screen of a computer or mobile device) of a customer, a financial firm or both, that enables a substantially real-time visualization of data concerning raw materials (e.g., historical data and current price), data concerning contract outcomes (e.g., simulated covered outcome, simulated uncovered outcome), a way to toggle through various scenarios while achieving substantially instantaneous output based upon a user-initiated query, or both.

In one of the illustrated examples of the present disclosure, a contract is the subject of a transaction. More particularly, the contract illustrated involves a customer, seeking to mitigate price risks associated with purchase or sale of a raw material, and a financial firm agrees upon a price limit for the contract, and optionally other terms and conditions, by which the financial firm is willing to guarantee to the customer that the customer will be financially reimbursed by the financial firm to offset additional raw material costs incurred by the customer when prices rise or decrease in the physical market above or below the defined price limit.

In one of the illustrated examples of the present disclosure, the contract illustrated involves a buyer—a financial firm in this instance—seeking to offset the risk the buyer took upon serving as a seller in other contracts.

In one of the illustrated examples of the present disclosure, the transacting parties agree upon a fixed price and the contract states that if the agreed upon settlement price (e.g., according to a specified price index) is higher or lower than the fixed price, then one of the transacting parties will financially reimburse the other of the transacting parties. The price index may be chosen from one of a variety sources. The transaction of this example may be referred to as a “fixed price swap” or a “swap”.

In one example of a contract outcome, there may be an outcome in which both parties are obligated to payout to one another depending on whether a price is higher or lower than a defined fixed price. For example, a contract may be settled monthly, where either side pays the other side depending if the monthly settlement price is higher or lower than the pre-defined fixed price.

As can be seen, by use of the transactions described in the present disclosure, a customer can help protect its raw material purchase costs in the event of an unforeseen price change for the raw material, and likewise, the financial firm can generate additional income by selling contracts and receiving a payment from the customer for carrying the raw material price risk. Similarly, a customer can help protect its raw material manufacturing cost in the event of an unforeseen price decrease for the raw material, and likewise, the financial firm can generate additional income by selling contracts and receiving a payment from the customer for carrying the raw material price risk. Customer and financial firm can do so by resorting to a unique and unconventional platform and data tools operated by the facilitator, providing transparency to each of the contract seller and buyer. As will be seen, use of the unconventional data tool of the present disclosure to transact a contract may function to generate revenue for a financial firm, mitigate risk for a customer, or both (i.e., mutually beneficial).

The customer may mitigate risk via the contracts by insulating against unpredictable market shifts. The contract may include a promise by the financial firm to pay the customer an amount of money based upon the occurrence of a trigger event (e.g., an option's strike price). More specifically, the financial firm may promise to remunerate the customer by an amount (i.e., “payout”) proportional to the change of a raw material's average market price, or any agreed upon result from the market or index prices throughout the contract duration (e.g., last price, maximal price, etc.) over an agreed upon price limit; the payout may be triggered in the event that the agreed upon result taken from the raw material market or index prices, (e.g., averaged over a period of time, last price, maxima price, etc.), surpasses an agreed upon price limit. Such a trigger event may or may not occur. For example, if the trigger event does not occur then there is no payout obligation upon settlement. As another example, if the trigger event does occur then there is a payout and either the financial firm obtains net positive revenue (i.e., if the payout is less than the financial firm's revenue from the premium) or the financial firm obtains net negative revenue (i.e., if the payout is more than the financial firm's revenue from the premium).

The risk of a buyer and a seller may be a function of certain historical occurrences. The risk of the buyer and the seller may be presented as a number of historical durations and the number of those durations in which the raw material price, or the function of raw material prices, historically changed by a specified amount (i.e., where the amount specified is the settlement parameter).

It may be appreciated by a person of reasonable skill in the art that, from the historical price of raw materials, one may derive a count of how many times, in intervals (e.g., monthly) during some period, a raw material price, or a function of raw material prices, has surpassed a settlement parameter. These historical occurrences may assist a customer, a financial firm, or both, in determining whether to transact in the contract. For example, if a customer selects a settlement parameter and finds that the historical price has surpassed the settlement parameter in only 2% of similar contract periods of the prior ten years, then the customer may determine that a contract, with this particular settlement parameter, is not favorable and thus the customer will decide not to transact in the contract.

### B. System

The system may function to perform the method as disclosed herein. The system may comprise computers, databases, dynamic databases, data sources, or both, connected via and electronic network. Particularly, the system may include one or more facilitator computers, one or more buyer computers, one or more seller computers, and one or more data sources.

The computers (i.e., “computing device”) may function to communicate via an electronic network, perform the method as disclosed herein, process data, store data, or any combination thereof. The computers may include one or more facilitator computers, one or more buyer computers, one or more seller computers, one or more server computers, data sources, or any combination thereof. One or more buyer computers may include one or more computers accessed by one or more contract buyers. One or more seller computers may include one or more computers accessed by one or more contract sellers. One or more facilitator computers may include one or more computers accessed by one or more facilitators. One or more server computers may be accessed by one or more of the transacting parties, other computers, or a combination thereof. One or more computers, or portions thereof, may be located onsite, remotely, or both from a facilitator, contract buyer, contract seller, or a combination thereof. One or more remote computers in communication with or accessible by an end-user may be considered a cloud-based computer. Cloud-based may mean that the one or more components may reside remote from an end-user in a non-transient medium while being accessible over a network, such as the Internet. One or more computers may be remote from one or more other computers, portions of the computer, or both. For example, a server computer may be located offsite and accessible by a facilitator computer, buyer computer, and/or seller computer located onsite. As another example, a facilitator computer located onsite may be in communication with another facilitator computer located offsite or the facilitator computer may only be located offsite and also accessible by the buyer computer and the seller computer. The computers may communicate with each other via an electronic network. The computers may comprise one or more databases, one or more dynamic databases, one or more processors, one or more non-transitory computer-usable mediums (e.g., storage medium), one or more caches, one or more servers, or any combination thereof. One or more of these computer components may be non-transitory, cloud-based, or both. The computers may connect to a display (i.e., a device, such as a computer monitor, which displays a graphical user interface).

The electronic network may function as the medium of communication between the one or more facilitator computers, the one or more buyer computers, the one or more seller computers, the one or more server computers, the one or more data sources, or any combination thereof. One or more networks may include one or more local area networks (LAN), wide area networks (WAN), virtual private network (VPN), intranet, Internet, the like, or any combination thereof

The non-transitory computer-usable medium may function to store the application, having instructions for carrying out the method as disclosed herein. The non-transitory computer-usable medium may instruct the processor to carry out the application. The non-transitory computer-usable medium may store one or more applications such as an application according to the present disclosure, a web browser (i.e. an application for accessing the electronic network to receive or transmit data), or any combination thereof.

The application (i.e., “computer program” or “computer-readable program code”) may function to direct the performance of a group of coordinated functions, tasks, activities, or any combination thereof. The application may be performed by the facilitator computer, the buyer computer, the seller computer, or any combination thereof. The application may interact with other applications, for example, a web browser.

The processor may function to carry out instructions of the application. The processor may be instructed, via the application, to perform operations including arithmetic operations, logic operations, control operations, input operations, and output operations. Particularly, the processor may be instructed to perform operations on parameters received from data sources or from other computers.

The database may function to organize a collection of data that is stored and accessed electronically. The database may organize parameters obtained from data sources, end-user inputs, and contract data (i.e., data from historical and current contract data, including but not limited to summary data and processed data), or any combination thereof. The term “dynamic database”, as referred to herein, may be a database typically used to store a large amount of data, and a proprietary program layer that uses the data stored along with additional data that arrives from data sources, continuously performs tasks (e.g., calculations on raw data, organization of data sets in response or anticipation of end-user interaction with the system, analysis of market conditions, analysis of risk factors of specific contracts, risk factors of specific raw materials, probability of outcomes, or any combination thereof). The dynamic database may also maintain copies of the organized data in various components of the system (i.e., “caching”) for the purpose of reducing the system response time to data requests initiated by the end-user.

The parameters may function to facilitate the buyer, the seller, or both to explore, visualize, and assess risks of a contract. The parameters may also function to assist the facilitator generate contracts. The parameters may include historical contract data (discussed in more detail below), historical prices of raw materials, current prices of raw materials, supply and demand trends, correlations between raw materials (e.g., prices of certain raw materials having a direct effect on the prices of certain other raw materials), economic indicators (e.g., interest rates and currency exchange rates, weather, geopolitical events, or any combination thereof). The parameters may be transitory (i.e., change during a period of a second, a minute, an hour, a day, a week, a month or even a year). The parameters may be obtained from one or more data sources via an electronic network. For example, historical prices of raw materials and current prices of raw materials may be obtained from public exchanges where the raw materials are traded on. Historical prices of raw materials and current prices of raw materials may be obtained from the New York Mercantile Exchange (NYMEX), data sources publishing price indices and benchmarks for various types of materials or industries. Price indices may be obtained via public or commercial data sources (data services). Examples of such sources may include government agencies, public exchanges (e.g., the New York Mercantile Exchange (NYMEX), the like, or any combination thereof), and data services (e.g., Bloomberg, Reuters, the like, or any combination thereof).

The historical contract data may function to improve the facilitator's ability to generate contracts and exemplify, to the buyer, the seller, or both, historical performance of contracts. The historical contract data may comprise data on contracts generated in accordance with the present disclosure. For example, the historical contract data may include specifications of generated contracts that did not result in an executed contract, specifications of generated contracts that were executed, user interactions with the system in regards to those contracts, events during the lifecycle of the contract, the summary information and processed data associated with each of the historical contracts, or any combination thereof. The historical contract data may indicate the performance of the system and method of the present disclosure. Said indication of performance may be viewable by the buyer, the seller, the facilitator, or any combination thereof.

The historical contract data may be utilized to automate a process of generating contracts. For example, the amount of exposure (i.e., risk) a seller has historically undertaken in prior contracts may indicate a finite number of price limits that the seller may seek to include in a contract specification. As a result, a system and method of the facilitator may propose one or more contracts, having specifications reflecting historical contract data of the seller, to the seller and the seller may choose to use the proposed contract.

The user interface may function as the medium of interaction between the computers and the buyer, the seller, the facilitator, or any combination thereof. The user interface may be a composite user interface (CUI). A composite user interface may be an electronic viewing hardware employing a graphical user interface (GUI) (e.g., displays, monitors, etc.) and human-machine interface (HMI) (e.g., peripheral input hardware which may include a keyboard, a mouse, voice, and other physical gestures, the like, or any combination thereof). The user interface may display graphics via a buyer display, a seller display, a facilitator display, or any combination thereof. The graphics may include one or more configurations including a customer dashboard, a financial firm dashboard, a customer contract summary, customer contract details, a financial firm contract summary, a financial firm contract details, reports and analysis tools of active and historical contracts, or any combination thereof. The configurations may organize data to facilitate the application's ease of use by an end-user.

One of the unique aspects of the present disclosure is the manner in which output of computer implemented aspects is graphically displayed to a user of the system, and the ease with which the user is able, via electronic viewing hardware (with or without any peripheral input hardware), to operate the system.

The buyer and the seller can enter an iterative process of negotiations in which each party may change the contract variables (e.g., price limit, premium, quantity). At the end of each negotiation stage, the current specifications are entered automatically as input into a simulator allowing rapid analysis of outcomes for these specifications.

The system enables the end-user to enter a set of contracts taking on the role as either buyer, seller, or both.

### C. Dashboard

The dashboard may function to display one or more contract groupings available to a financial firm, a customer, or both; to convey to the end-user the financial performance of active contracts (i.e., contracts currently transacted in and the duration has yet to lapse) and settled contracts (i.e., contracts having a duration that has elapsed and the transacting parties have paid out the requisite amount per the contract terms); or a combination thereof. The dashboard may be displayed when the financial firm, the customer, or both sign onto a website application. The contract groupings may sort contracts by the chronological stage of transaction in which the contracts are situated. The dashboard may comprise one or more widgets (i.e., elements of interaction on the user interface) associated with each of the one or more contract groupings. Some of the one or more contract groupings may be available to a financial firm but not to a customer and vice versa. Some of the one or more contract groupings may be available to both the financial firm and the customer. The widgets may be associated with customer contract specifications, pending contracts, contracts, or financial firm contract specifications, pending contracts, contracts, or both. The widgets may be associated with fixed price swaps, options, or to other types of financial price risk mitigation contracts.

The contract groupings available to a customer may include proposed specifications (i.e., proposed by the financial firm), offers pending acceptance (i.e., contracts the customer decided to transact in and pending the financial firm's decision to also transact in the contract), proof of payment required (e.g., payment of a premium by the customer to the financial firm), specifications awaiting response (i.e., specifications proposed by the customer and pending acceptance by the financial firm; in other words, specifications currently being negotiated), confirmations awaiting signature (i.e., contracts in which both parties have decided to transact in but which require a signature in order to bind the parties to the contract), awaiting activation (i.e., contracts which have been signed by both parties but which have a start date occurring on a later date), or any combination thereof. Access to each contract grouping available to a customer may be provided via a sub-window, tab, or both within a user interface accessible to a customer.

The contract groupings available to a financial firm may include available specifications (i.e., contracts made available to customers), interested parties awaiting response (i.e., contracts by which customers have expressed interest and the financial firm is now in a position to respond to the customers), offers pending acceptance, (i.e., contracts the financial firm decided to transact in and pending the customer's decision to also transact in the contract), confirmations awaiting signature (i.e., contracts in which both parties have decided to transact in but which require a signature in order to bind the parties to the contract), or any combination thereof. Access to each contract grouping available to a financial firm may be provided via a sub-window, tab, or both within a user interface accessible to a financial firm.

The dashboard may also display other information that a financial firm, a customer, or both may find useful such as the number of active contracts, the quantity of raw materials covered under the active contracts, the number of settled contracts, mark-to-market (“MTM”) portfolio value, notification dots, or any combination thereof. The notification dots may indicate the number of contracts in a particular contract grouping.

### D. Contract Summary

The customer contract summary and the financial firm contract summary may function to display relevant data associated with a contract in a compact manner, enabling the customer and the financial firm respectively, to navigate through one or more contracts. The customer contract summary and the financial firm contract summary may display summary data that enables a customer, a financial firm, or both to efficiently determine the desirability (i.e., the extent of financial gain or loss, the extent of risk mitigated, market conditions, historical occurrence assessment, profit or loss values of outcomes, possibility of outcomes and their values, potential counterparty to the contract, or any combination thereof) of the contract. The summary data may include contract specifications (e.g., raw material type and duration), contract variables (e.g., price limit, quantity, and premium), or both. The summary data may also be referred to herein as contract terms, economic terms, or both. The customer contract summary and the financial firm contract summary may also include processed data (e.g., risk assessment, simulated covered outcome, simulated un-covered outcome, simulated no-payout outcome, simulated payout outcome, current market conditions, historical data, etc.). The summary data may include at least contract specifications and contract variables to convey a suitable amount of data (i.e., the least amount of data in order for an end-user to determine a threshold interest in the contract) without visually encumbering the end-user. The summary data and processed data may be selectively displayed based upon the end-user's customization. The summary data and processed data may be specifically tailored, in a default configuration, to either the customer contract summary or the financial firm contract summary. It may be appreciated by one of skill in the art that the extent of data displayed with the customer contract summary and the financial firm contract summary may be reduced, expanded, or presented in various visual configurations. One or more contract summaries may be displayed as visually associated with one or more contracts (e.g., within the same visual boundary).

It may be appreciated by a person of reasonable skill in the art that contract specifications are provided by a customer, a financial firm, or both. The processed data may be data derived from the contract specifications.

The input information may function to elicit an output from the application. The input information may include contract specifications (e.g., a material type, a duration, or both), contract variables (e.g., price limit, quantity, premium, or any combination thereof), a settlement parameter, or any combination thereof. The input information may be selectively input by end-users, a facilitator, or both, via an HMI. The input information may be numbers, strings, booleans, text or any combination thereof. The input information may be chosen from a substantially continuous range or chosen from a discrete set of options. The input information comprising contract specifications, contract variables, or both, may enable the end-users to receive and view only contracts relevant to the transactions the end-users desire to engage. For example, a customer may narrow the contracts to review by first selecting a raw material type and next selecting a duration; from there the customer may further narrow the contracts to review by selecting a quantity of the raw material the customer desires to purchase over the duration of the contract. The input information, including the contract specifications and the contract variables may include additional data, including but not limited to customer and financial firm ID (e.g., such that a customer can select their preference of financial firm and vice versa), raw material source, start date, number of contracts (e.g., a buyer may choose to engage in multiples of the same contract), contract ID (e.g., to locate a contract that is in a stage of negotiation), and data source (e.g., a buyer, a seller, or both may have a preferred data source that is afforded higher regard or trust than other data sources). The one or more contracts may be sorted in accordance with input information. For example, the end-user may direct, via input information, that contracts be sorted in order from highest price limit to lowest price limit. The one or more contracts may be sorted manually by the end-user. For example, the end-user may click on a contract summary and drag it into a different position, where the position indicates priority (e.g., higher or lower in a vertically ordered list).

The contracts may be automatically generated (e.g., by the facilitator computer, by the financial firm computer, by the customer computer) in accordance with parameters (discussed above) and the input information, where the parameters are dynamically changing with market conditions. The contracts may be automatically generated in accordance with an algorithm to produce one or more contracts having various contract variables. The contracts may be automatically generated having various contract variables, in a range of variables identified by the algorithm as desirable to the end-users (i.e., viable scenarios that end-users would like to protect themselves against). The contracts may be updated in substantially real-time with respect to the input information of the end-user or upon the dynamic database collecting new information from data sources. The contracts may be updated in substantially real-time with respect to the parameters. The contracts bearing specific contract specifications and specific contract variables may be organized in the facilitator's dynamic database and the input information provided by the end-users prompts retrieval of a contract bearing the requisite contract specifications and contract variables. The pre-generation of the contracts may be achieved via operations performed on parameters retrieved from data sources in addition to data from historical contracts, where the parameters and historical contracts are chosen on the basis of the input information (i.e., contract specifications).

The contract specifications may function to broadly categorize contracts. The material type may indicate the proper identity, grade, or otherwise relevant characteristic of the raw material. The duration may refer to the duration of the contract. The duration may be a period of weeks, months, years, the like, or any combination thereof. For example, the duration may be selected from a discrete selection of time periods measured in months (e.g., 12 months, 9 months, and 6 months). The durations presented for selection to the buyer, the seller, or both may be dependent on the raw material type. The durations may be related to the volatility of the raw material (i.e., the statistical measure, expressed as either a standard deviation or a variance, of the dispersion of price fluctuations for a given raw material).

The contract variables may function to indicate alternatives for the end-user to determine a desirable contract to purchase or sell (i.e., approve), if any. The price limit may be the limit of the contract over which a payout may be triggered. The price limit may be presented as a price per unit, where the unit may be customary to a specific raw material (e.g., polyethylene may be measured in pounds, crude oil may be measured in barrels, etc.). The quantity may be a quantity of a raw material that will be covered under the contract (i.e., a payout by the seller may be proportional to the quantity). The premium may be the amount agreed by the buyer as payable to the seller upon both the seller and the buyer accepting the contract.

### E. Contract Details

The customer contract details and the financial firm contract details may function to display summary data, processed data, or both, enabling the customer, the financial firm, or both to analyze and ultimately decide to transact in or decline to transact in the one or more contracts. The customer, the financial firm, or both may selectively switch from viewing contract summaries to contract details. For example, given a list of several contracts, the customer, the financial firm, or both may first view the contract summaries and thereafter selectively access the contract details in chronological succession in accordance with the order the contracts appear on the display. The contract details of more than one contract may be selected simultaneously such that the contract details of more than one contract may be compared with ease by navigating up and down the page. The customer contract details and the financial firm contract details may include processed data in addition to summary information (i.e., contract specifications, contract variables, or both).

The processed data may function to aid a customer, a financial firm, or both in analyzing contracts in order to determine the desirability of entering into a specific contract. The processed data may be generated by the facilitator computer, in response to inputs from the end-user. The processed data may include a risk assessment, a simulated covered outcome, a simulated un-covered outcome, a simulated payout outcome, a simulated no-payout outcome, historical occurrence assessment, historical data, or any combination thereof. The processed data may include different data tailored to either a customer or a financial firm. By way of example, the processed data, tailored to a customer, may include a risk assessment, a simulated covered outcome, a simulated un-covered outcome, historical data, or any combination thereof. The processed data, tailored to a financial firm, may include a risk assessment, a simulated payout outcome, a simulated no-payout outcome, historical data, an exposure value (i.e., cost of a quantity of the raw material according to the unit price published at the commencement of the contract), a value at risk (“VaR”) (i.e. statistical measure of the level of financial risk for a specific contract or for an investment portfolio), or any combination thereof. The processed data may be generated as a function of the contract specifications, the contract variables, and a settlement parameter.

A financial firm may also act as a buyer, seller, or both of contracts and in so doing, the processed data visible to the financial firm may include processed data tailored to a customer.

The settlement parameter may function to imply the outcome (i.e., whether or not the settlement parameter will exceed or fall short of the price limit or an agreed upon trigger) of the contract. The settlement parameter may be any agreed upon function that is determined by a set of hypothetical prices. The settlement parameter may include a hypothetical average price over the duration of the contract, a hypothetical last price (i.e., the last price in the contract duration), a hypothetical maximal price (i.e., maximal price occurring within the contract duration), a hypothetical minimal price (i.e., the minimal price occurring within the contract duration), and the like. The settlement parameter may drive the output of simulations to aid the end-users in analyzing the risk of a contract and comparing the risk of two or more contracts by enabling transparent and rapid comparison of an outcome covered by a contract with an outcome not covered by a contract. The simulations may include a simulated covered outcome, a simulated un-covered outcome, a simulated payout outcome, a simulated no-payout outcome, or any combination thereof. The settlement parameter may be a hypothetical price of a raw material represented as a price per unit. The settlement parameter may be selectively chosen from a substantially continuous range by a selector. The substantially continuous range may include any number, between a minimum and a maximum, having a decimal not exceeding ten thousandths of an integer. The number of the substantially continuous range may have a decimal that does not exceed one hundredths of an integer. The minimum and maximum values presented may be determined as a function of the parameters (i.e., the summary data). The selector may be a metaphor of a real-life object conventionally manipulated to select a position from a range of positions (i.e., “control element” or “widget”). More particularly, the selector may be a slider, a dial, a lever, or the like. The settlement parameter may be computed from selectively choosing a set of hypothetical prices for the duration of the contract. For example, a transacting party may use its own proprietary or discretionary tools for analyzing contracts and input hypothetical prices for intervals over the duration of the contract.

The simulated covered outcome may function as a representation of the financial outcomes for each of the transacting parties as a result of purchasing or selling a contract. The simulated covered outcome may include a total covered cost, which may be a function of the current price of the raw material at the time, the price limit, the premium, the quantity, or any combination thereof. The simulated covered outcome may further display the price limit and the sum of the price limit and the premium or the subtraction of the premium from the price limit, for the purpose of comparison with the simulated un-covered outcome. In other words, the simulated covered outcome shows the buyer what it will pay for the desired quantity of the raw material if it is assumed that the settlement price of the raw material stays at the price limit (although, the customer is not obligated to purchase the raw material at the price limit, the customer only pays the current market price for the raw material at the time of the transaction, which may be lower than the price limit). In the example of a contract that protects the customer from raw material price increase, the sum of the price limit and the premium may indicate to the customer the threshold that, if exceeded by the simulated settlement parameter, the customer is paid an amount that improves the customer's financial position as compared to the customer's position without the contract (i.e., the customer's costs were offset by the payout from the contract by the financial firm). In the example of a contract that protects the contract buyer from raw material price decrease, the difference of the premium from the price may indicate to the contract buyer the threshold that, if the simulated settlement price is lower than said difference, then the contract buyer is paid an amount that improves the contract buyer's financial position as compared to the contract buyer's position without the contract (i.e., the contract buyer's costs were offset by the payout by the contract seller).

The simulated un-covered outcome may function as a representation of the financial position of the customer as a result of not purchasing the contract. The simulated un-covered outcome may include a total un-covered cost, which is a function of the settlement parameter and the quantity. The simulated un-covered outcome may further include a settlement parameter, which may be displayed for the purpose of comparison with the simulated covered outcome.

The simulated no-payout outcome may function as a representation of the financial position of the financial firm as a result of the average price (i.e., the average price of the raw material during the duration of the contract) not exceeding the price limit (i.e., trigger event not taking place). In such a scenario, the financial firm would not be obligated to pay the payout to the customer. The simulated no-payout outcome may be utilized by a financial firm when acting as a seller of contracts (i.e., selling a contract to a customer or another financial firm) or when acting as a buyer of contracts (i.e., buying a contract from another financial firm). The simulated no-payout outcome may include a premium revenue, which may be a function of the premium and the quantity, a price limit, a current price, or any combination thereof

The simulated payout outcome may function as a representation of the financial position of the financial firm as a result of the settlement parameter (e.g., the average price of the raw material during the duration of the contract) exceeding the price limit in the example of the contract that protects the customer from a price increase, or falling short of the price limit in the example of contract that protects the customer from a price decrease (i.e., trigger event taking place). In such a scenario, the financial firm would be obligated to pay the payout to the customer. The simulated payout outcome may be utilized by a financial firm when acting as a seller of contracts or when acting as a buyer of contracts. The simulated payout outcome may include a simulated total payout, a simulated net revenue, or both. The simulated total payout may be a function of the settlement price in excess of the price limit and the quantity. The simulated net revenue may be a function of the simulated total payout and the premium revenue. The simulations described above may consider a set of contracts (i.e., portfolio), of the customer or the financial firm, currently being transacted in. The simulation may consider the contract specifications and contract variables of one or more contracts in the portfolio; then consider the contract specifications and contract variables of a contract a transacting party is currently assessing; and then present a portfolio outcome. The portfolio outcome may imply the profit or loss embodied in the portfolio with and without the contract currently being assessed. The portfolio outcome may be a hypothetical figure that may not be pre-determined due to the contract outcomes of the contracts in the portfolio not being certain.

The historical data may function to indicate raw material price statistics (e.g., maximum price, minimum price, average price, moving average of price, or any combination thereof) over a period of time, price trends, and assist in ascertaining a probability of a trigger event. The historical data may comprise data points for any period of time in the past, where the data points are prices of a raw material at any given point in time. The historical data may be obtained through consumer or other price indices. The historical data may be presented as a scatter plot, a line graph, a bar graph, candles, a table, or any other suitable format of presenting data. The historical data may be presented as a line graph, where the x-axis may be measured in time and the y-axis may be measured in price. The historical data may be selectively presented for a period of time in the past (from present). The historical data may be selectively presented for a period of one month or more, 6 months or more, 2 years or more, 10 years or more. The historical data may indicate the current price of the raw material (i.e., current market price according to a price index, updated in substantially real-time). The historical data may include overlay data, which may function to augment the presentation of the historical data. The overlay data may include an indication of the price limit (e.g., a line defined by a point on the axis bearing the price), minima and maxima of prices during certain periods, moving averages, comments linked to points in time where the comments are relevant to events (e.g., an indication of a geopolitical event that caused a price fluctuation), or any combination thereof.

The risk assessment may function to summarize data from the simulated covered outcome, the simulated un-covered outcome, the simulated no-payout outcome, the simulated payout outcome, the historical data, or any combination thereof, and enable the end-user to rapidly assess a contract. The risk assessment may include data most relevant to the end-user, in summary format, for the end-user to make a decision as to whether a contract is desirable. The risk assessment may include the settlement parameter, the difference between the settlement parameter and the current price, a historical occurrence assessment (e.g., an assessment of the settlement parameter based on historical price behaviors under certain market conditions), a projected payout, contract parameters, contract variables, or any combination thereof. The difference between the settlement parameter and the current price may be indicated as a raw difference in price per unit or a percentage. The historical occurrence assessment may function to indicate a probability of the average price of the raw material, during the duration of the contract, exceeding the price limit of the contract. The historical occurrence assessment may be expressed as a percentage of occurrences, where the average price of the raw material exceeded the price limit. For example, if the duration of the contract is 12 months, the historical occurrence assessment will indicate how many 12 month periods, from a selectable start date, included an average price that exceeded the price limit, which may be expressed as a percentage of the total number of 12 month periods from the selectable start date.

One aspect of the present disclosure is addressed to an improved user interface that provides more functionality than historically has been available. It is possible with the present disclosure to employ within a single window multiple sub-windows depicting interactive elements, simulations (outputs) (e.g., simulated covered outcome, simulated un-covered outcome, contract outcome, risk assessment, or any combination thereof) for contracts based upon user inputs (e.g., settlement parameter), or both, where the outputs generated by the inputs are generated in substantially real-time. By way of example, one approach is to include at least three or four discrete sub-windows of a single window. One of the sub-windows includes a visual depiction of a controllable input (interactive element) for the end-user (e.g., a substantially continuous range by which a settlement parameter is chosen by a selector). The interactive element may be elongated, arcuate, or circular. The interactive element may extend half the length of the window or more. The interactive element may be located offset from the other sub-windows. The interactive element may be located in a central portion, a side portion, a top portion, or a bottom portion of the display. Two or more of the sub-windows may be employed to graphically display (with or without alphanumeric characters) the result of simulations performed by a computer using historical data and based upon the input from the end-user, via the interactive element sub-window. The two or more sub-windows, graphically displaying the simulations, may be located side-by-side or one on top of the other. Optionally, one or more region may include a graphical display of historical data (without a simulation). The multiple sub-windows and the interactive element may be viewable simultaneously and arranged strategically to aid the end-user in comparing different simulated scenarios.

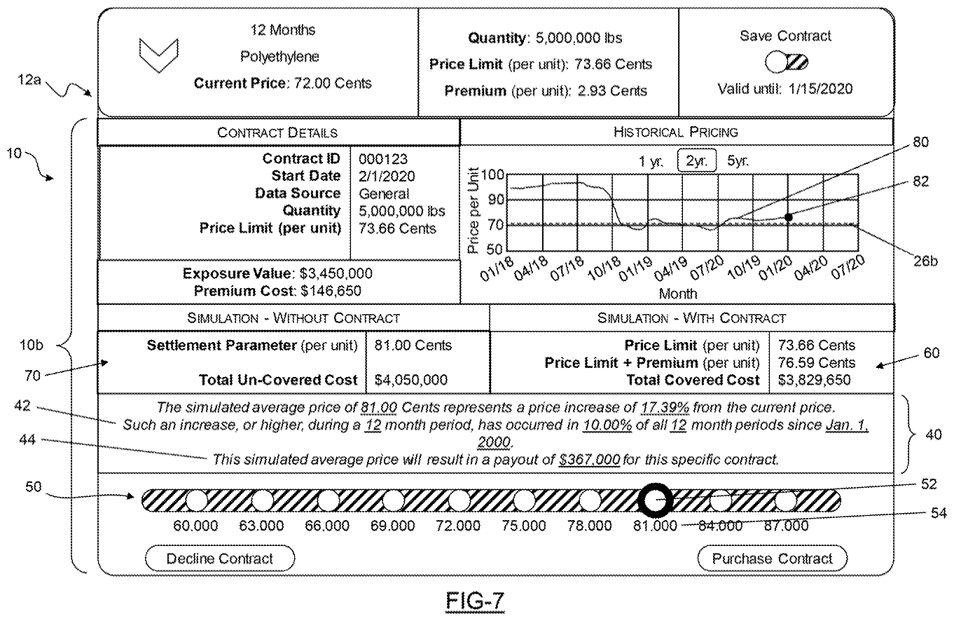

One of the features of the present disclosure is that the controllable input (interactive element) can be manipulated by the end-user resulting in the substantially real-time update in display of the other discrete regions. In other words, as the end-user uses an input device (e.g., mouse or touch screen) to change a position of the selector, additional calculations are caused to be performed by the system with the resulting simulations being graphically displayed in the discrete sub-windows of a single window. To further illustrate this example, reference is made to FIG. 7. As shown, the two or more simulations are located side-by-side and above the controllable input.

Based on the above it can clearly be seen that there are several advantages is an unconventional simultaneous depiction of multiple different simulations and historical data in a single screen, also including the graphical display of the input upon which the simulations are based.

It may be appreciated by one skilled in the art that the user interface may be arranged in any number of ways so as to assist the customer, the financial firm, or both to efficiently view the data (e.g., contract specifications, contract variables, processed data, or any combination thereof) discussed above. Data may be repeated in different segments of the user interface. Data may be displayed in proximity to other data in order to indicate that one or more pieces of data were utilized in order to calculate one or more other data. For example, the price limit and quantity may be displayed in proximity to a total covered cost, on the user interface, to indicate to the customer that the price limit and the quantity were used to calculate the total covered cost.

### F. Method

The present disclosure provides for the following method.

Generally, the end-user may interact with the application, which may be a thin-client application (i.e., browser-based application wherein the substantive computing is performed by the facilitator computer, server computer, or both), via a browser stored on the non-transitory computer-usable medium of the end-user's computer. The facilitator computer, server computer, or both and the end-user computer may communicate via packets (i.e., collections of data sent between computers communicating via an electronic network). For example, available contracts, updated in substantially real-time, are generated by the facilitator computer, server computer, or both and sent via packets to the customer computer.

The dynamic database may be updated in substantially real-time with parameters from the data sources either in pull mode (i.e., dynamic database prompts the data sources for data) or push mode (i.e., data sources send data to the dynamic database without a prompt). The dynamic database may perform a variety of functions on the parameters (e.g., calculations, sorting, and storage). Specifically, the dynamic database may obtain historical prices, current prices, or both from the data sources and calculate simulations based on that data. The dynamic database may send parameters (e.g., historical prices, current prices, or both) and pre-calculated simulations to the end-user computer to be stored in a cache on the end-user computer, where the historical price, current price, or both may be conveniently accessed. The dynamic database may update the end-user computer's cache in substantially real-time as parameters from data sources are updated in the dynamic database.

Contracts and the terms of the contracts (e.g., contract parameters and contract variables) may be generated by the facilitator computer based upon parameters and calculations derived from the parameters, which are updated in substantially real-time on the dynamic database, in response to dynamic market conditions. Contracts may also be generated manually by a facilitator, by the financial firm, or by affiliate of the facilitator. The generated contracts may be stored in the database, the dynamic database, the cache of the customer, the cache of the financial firm, or any combination thereof

Where the end-user is a customer, the customer may view contracts via the customer contract summary displayed in the browser. The customer may navigate the browser page, to view the contracts provided by the customer contract summary. The customer may view the contract specifications and contract variables of each contract shown, via the buyer contract summary, and select a contract to view the customer contract details, via a button displayed as associated with a contract. The customer may select (such as via a button) more than one contract to view, compare, or both, the customer contract details. Upon selection of one or more contracts, the customer's cache may be queried for data specific to a contract that will be displayed in a customer contract details. Where the cache does not have the required data, a packet containing information may be sent to the facilitator computer, which queries the dynamic database for the most up-to-date data relevant to the specific contract examined and said data may be returned to the facilitator computer, transmitted to the customer computer, and made available for display on the GUI. To take further advantage of the disclosure herein, consisting of displays enabling analysis of extensive data and multiple factors (in order to examine the desirability to enter a contract based on price risk mitigation needs) the customer may select a settlement parameter via the customer contract details. Selecting a settlement parameter may query the customer computer cache for processed data (e.g., a simulated covered outcome or a simulated un-covered outcome). Where the customer computer cache does not have the data, the customer computer may send a packet, containing the settlement parameter, to the facilitator computer, to obtain processed data in substantially real-time. The customer may repeat the steps of selecting a settlement parameter and obtaining processed data for any number of iterations. Each iteration of the customer selecting a settlement parameter and obtaining processed data may enable the customer to make an informed decision to purchase a contract by viewing the simulation results that are produced by each iteration and assessing the risk of each simulated outcome. Upon reviewing any number of contracts by performing the above method, the customer may choose to purchase the contract; confirming the decision via a button. The customer may choose to decline contracts, in which case the customer may select a button to decline the contract. Upon declining the contract, the contract may be removed from the customer contract summary. The customer's decision to purchase or decline a particular contract may be then communicated to the facilitator computer via the electronic network for further processing (e.g., registering the decision in the database, reporting or both).

Where the end-user is a financial firm, the financial firm may view contracts, transact with customers (i.e., “available contracts”), or both via the financial firm contract summary displayed in the browser. The contracts viewable by a financial firm may be updated in substantially real-time, such as upon purchase of the contracts by customer. The available contracts may be stored on the financial firm computer cache or obtained, through query, from the facilitator computer. The financial firm may navigate the browser page, to view the contracts provided by the financial firm contract summary. The financial firm may view the contract specifications and contract variables of each contract shown, via the financial firm contract summary, and select a contract to view the financial firm contract details. The financial firm may select, via buttons, more than one contract to view, compare, or both, the respective financial firm contract details. In selecting one or more contracts, via a button, the financial firm's cache may be queried for data specific to a contract that will be displayed in the financial firm contract details. Where the cache does not have the required data, a packet containing information may be sent to the facilitator computer, which queries the dynamic database for the most up-to-date calculated data sets relevant to the specific contract examined and said data may be returned to the facilitator computer, transmitted to the financial firm computer, and made available for display on the GUI. To take further advantage of the disclosure herein, consisting of displays enabling analysis of extensive data and multiple factors (in order to examine the desirability to enter a contract based on price risk mitigation needs), the financial firm may select a settlement parameter via the seller contract details. Thereafter, the financial firm may obtain processed data from the facilitator in substantially real-time. The financial firm may repeat the steps of selecting a settlement parameter and obtaining processed data for any number of iterations. Each iteration of the financial firm selecting a settlement parameter and obtaining processed data may enable the financial firm to make an informed decision to approve a contract by viewing the simulations that are produced by each iteration and assessing the risk of each simulation. Upon reviewing any number of contracts by performing the above method, the financial firm may choose to approve the contract; such as by confirming the decision via a button. The financial firm may choose to initiate a subsequent negotiation step. The subsequent negotiating step may include providing proposed changes to the customer for the customer to approve. The financial firm may choose to decline contracts, in which case the financial firm may select a button to decline the contract. Upon declining the contract, the contract may be removed from the financial firm contract summary.

The facilitator may obtain a settlement parameter from the end-user via an electronic network. Upon receiving the request, the facilitator computer may communicate with the dynamic database to request and obtain the most up to date calculated data (e.g., historical data, analysis of current market conditions based on multiple factors and information stored in the database), wherein the data may be related to the contract specifications (e.g., the facilitator computer requests the dynamic database access data relating to a certain raw material type and specific contract parameters). Upon obtaining the data, the facilitator may process the data via a processor to generate a simulated outcome. The facilitator then may send data sets (e.g., the simulated outcome) to the end-user. The data sets may be cached on the end-user computer (even without a specific query for information by the end-user) to improve response time. The facilitator may repeat the steps of obtaining a settlement parameter, sending a request for data from a dynamic database, obtaining data from a dynamic database, generating processed data, and sending processed data to the end-user for any number of iterations as directed by the end-user's repeated selection of a settlement parameter.

The dynamic database may store parameters which may be updated in substantially real-time, via an electronic network, by information received from data sources. The application stored on the non-transitory computer-usable medium may instruct the facilitator computer to extract data from a data source. For example, the facilitator computer may extract data from a data source containing a raw material price index or other economic indicators. Some data may be sent, via an electronic network, to the facilitator computer and the data may be handled locally. For example, the facilitator may subscribe to services (e.g., business reports, market data services, federal agencies reports, bank reports, etc.) disseminating information as to various raw materials and said services may send data to the facilitator computer.

The dynamic database may store historical and current contract data, which may include summary data and processed data. The dynamic database may store contracts that were declined by buyer, approved by buyer but declined by seller, or approved by both buyer and seller. The dynamic database may store information about the complete lifecycle of a contract, including the interaction of the end users with the contract views in the respective contract details views (buyer or seller).

During a negotiation stage of the contract (i.e., negotiation between the transacting parties), the transacting parties may communicate with each other via the system of the present disclosure and propose changes to any of the contract specifications, contract variables, or both. The system of the present disclosure may provide a GUI specifically for the negotiation stage of the contract. The GUI may display the contract specifications, contract variables, or both, that may be altered (e.g., reducing the quantity, increasing the premium, lengthening the duration, or any combination thereof). The GUI may display a record of past revisions to the contract. After each stage of negotiation in which a contract specification or contract variable is changed, the simulator of the present disclosure may be updated in substantially real-time. During the negotiation stage, the transacting parties may be able to access the simulations, such as depicted in FIGS. 7, 9, and 10. The transacting parties may access the simulations in a short period of time and in a manner that does not prolong the negotiation timeline to an appreciable degree. For example, a financial firm may access its dashboard and find that a customer has proposed a change to the premium on a proposed contract and so the financial firm may substantially instantaneously view the simulations with the proposed change to the premium factored-in.

### Illustrative Examples

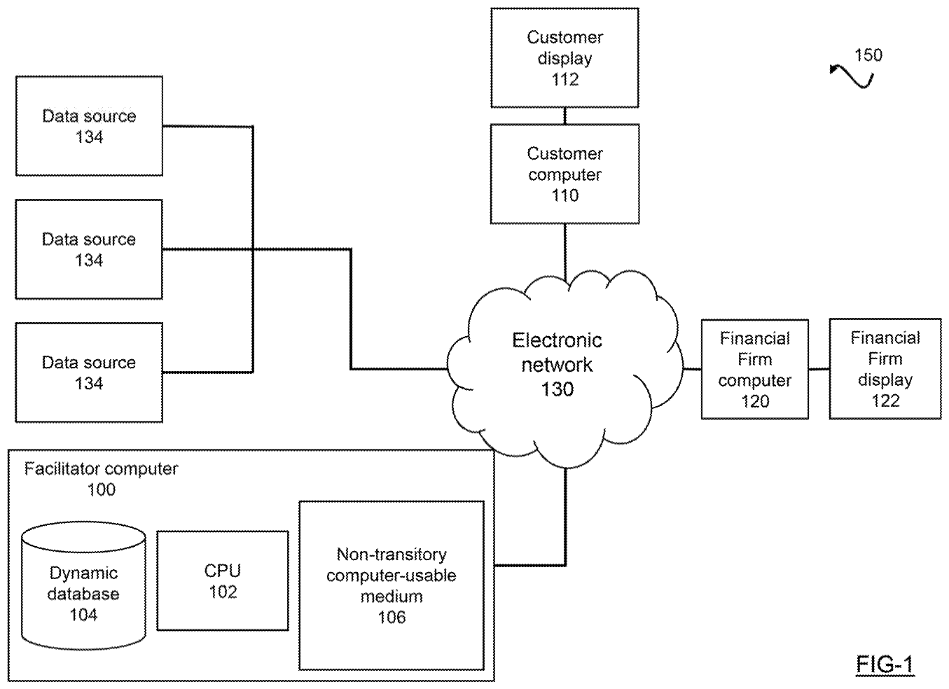

FIG. 1 illustrates a schematic view of the system 150. The system 150 includes a facilitator computer 100, a customer computer 110, a financial firm computer 120, and one or more data sources 134 connected via an electronic network 130. The customer computer 110 and financial firm computer 120 include a customer display 112 and a financial firm display 122, respectively, upon which a user interface (not shown) may be displayed. The facilitator computer 100 includes a processor 102, a non-transitory computer-usable medium 106, and a dynamic database 104.

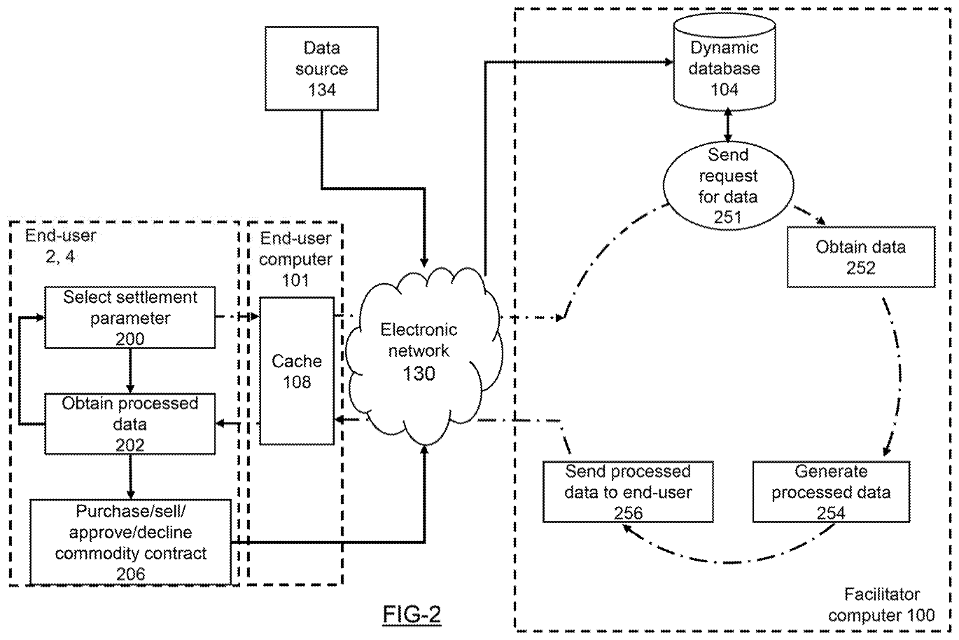

FIG. 2 illustrates a flow diagram of an end-user 2, 4, end-user computer 101 and a facilitator computer 100 performing the method as set forth in the present disclosure. An end user 2, 4 first performs the step of selecting a settlement parameter 200, which queries the cache 108 for processed data related to a contract. The cache 108 is updated, via an electronic network 130, by the facilitator computer 100. The facilitator computer sends a request for information from a dynamic database 104. The dynamic database 104 is updated in substantially real-time, via an electronic network, with parameters (not shown), including historical prices and price risk analytics data, from one or more data sources 134. The facilitator computer 100 then obtains the data 252 from the dynamic database 104, generates processed data 254, and sends the processed data 256 (data comprising the simulated outcome, the risk assessment, and the historical data) to the end-user 2, 4 via the electronic network 130. The end-user computer 101 obtains the processed data 202 from the facilitator computer 100 whereupon the end-user computer 101 may store the processed data in the cache 108. Then the end-user 2, 4 may view/analyze the processed data. The end-user 2, 4 may repeat the steps 200 through 202 for any number of iterations to satisfy the end-user 2, 4 in making a decision to purchase/sell/approve/decline the contract 206. The decision 206 is then transferred to the facilitator computer 100 via the Electronic Network 130.

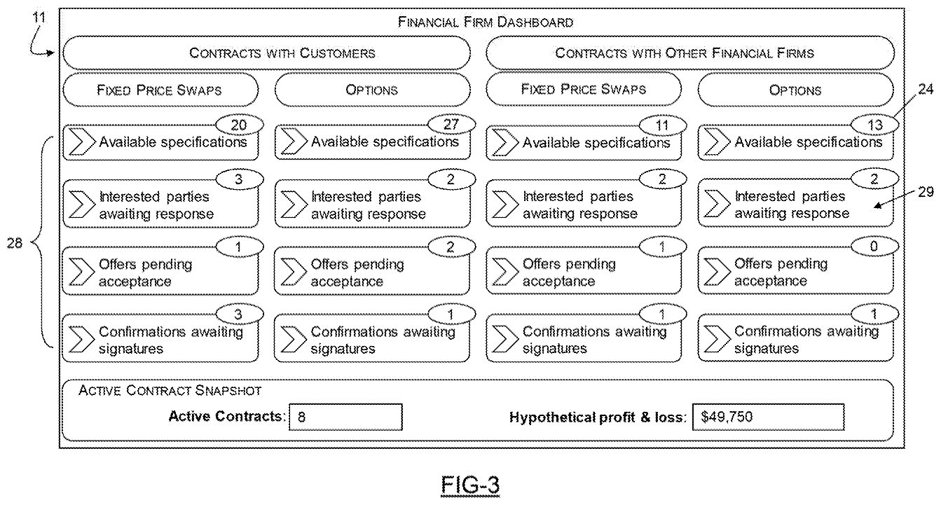

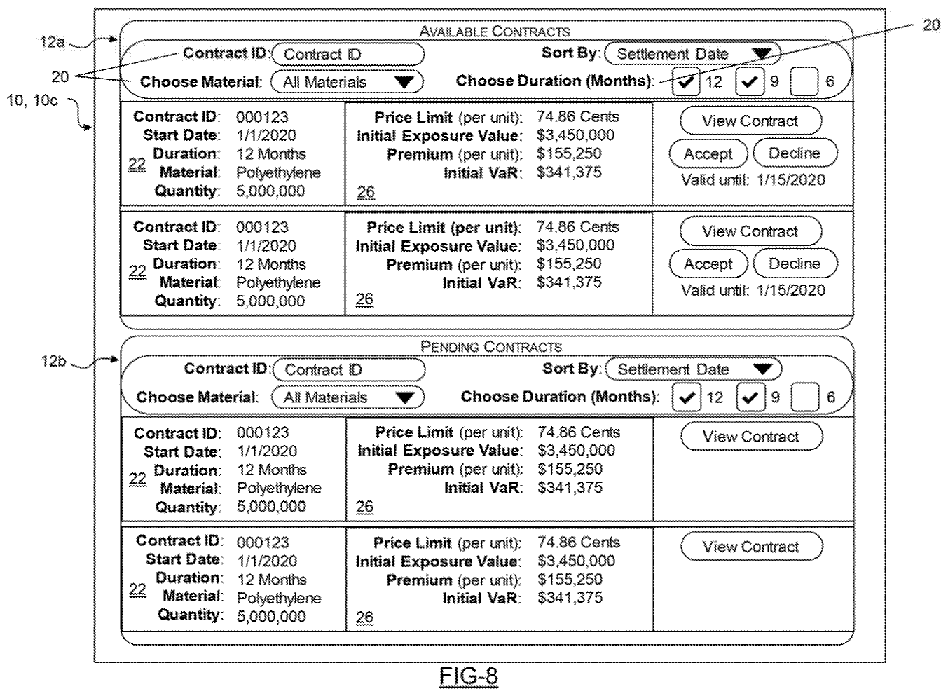

FIG. 3 illustrates a financial firm dashboard 11. The financial firm dashboard 11 displays a visually simple and concise summary of contract groupings 29, which are accessed via widgets 28 distributed across the financial firm dashboard 11. Contract groupings 29 may be sorted by contracts with customers or contracts with other financial firms. Associated with both the customers and the other financial firms are fixed price swaps and options. Selecting each of the widgets directs the financial firm to a user interface such as what is illustrated in FIG. 8. Each of the widgets include a notification dot 24, which indicates the number of contracts in the contract grouping.

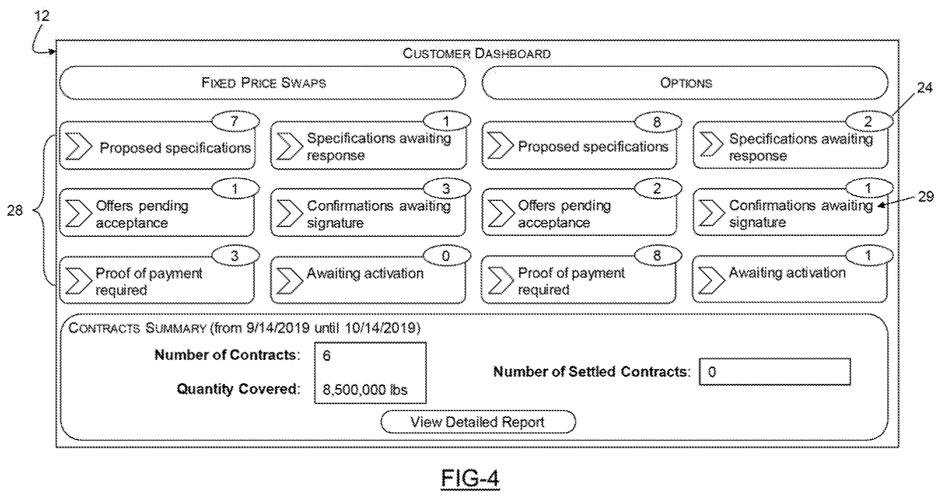

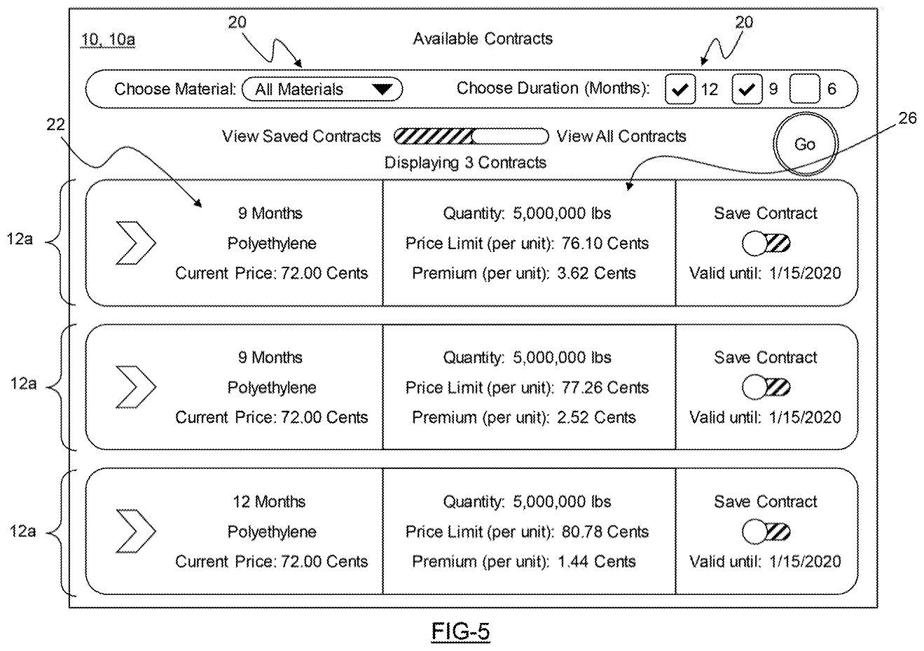

FIG. 4 illustrates a customer dashboard 12. The customer dashboard 12 displays a visually simple and concise summary of contract groupings 29, which are accessed via widgets 28 distributed across the customer dashboard 12. Contract groupings 29 may be sorted by fixed price swaps and options. Selecting each of the widgets directs the customer to a user interface such as what is illustrated in FIG. 5. Each of the widgets include a notification dot 24, which indicates the number of contracts in the contract grouping.

FIG. 5 illustrates a user interface 10. The user interface 10 includes a customer contract summary 10a, which lists available contracts 12a, which are generated in response to input information 20 (contract specifications) from a buyer. The contract specifications include raw material type (selectable from a drop-down menu, as shown) and duration. As shown, the buyer may select one or more durations (12 months, 9 months, and 6 months). In response to the input information 20, corresponding available contracts 12a are displayed. As shown, three available contracts 12a, each defined by contract specifications 22 (duration, raw material type), chosen by the buyer, and contract variables 26 (quantity, price limit, premium), generated by a facilitator, are displayed. Each available contract 12a also shows a current price.

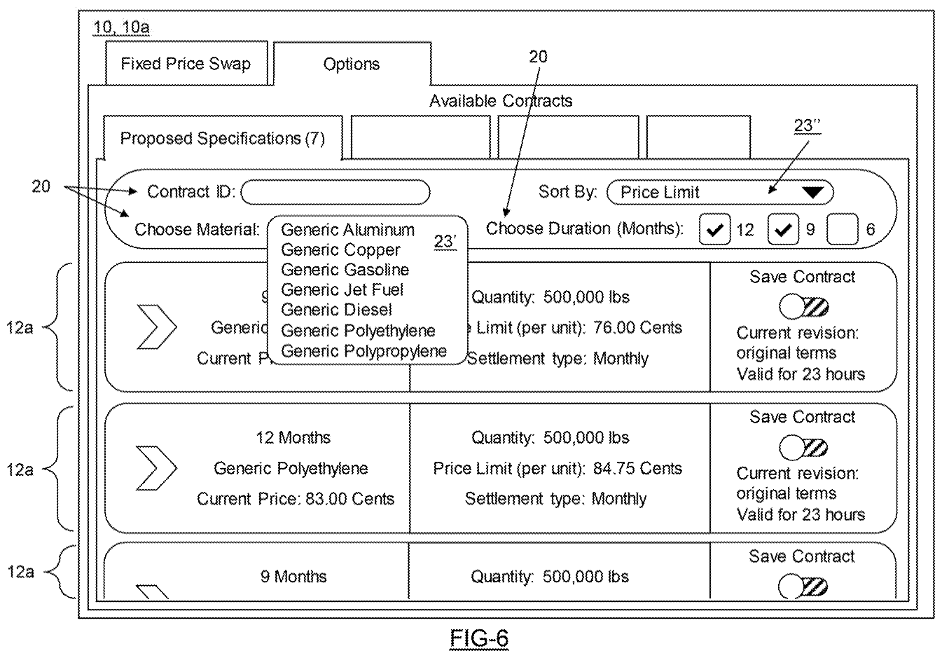

FIG. 6 illustrates a user interface 10. The user interface 10 includes a customer contract summary 10a, which lists available contracts 12a. Available contracts 12a are displayed according to input information 20 (contract ID, raw material type, duration). A drop-down menu 23′ lists all raw material types associated with the particular customer. A drop-down menu 23″ designates how the available contracts 12a will be sorted on the user interface 10.

FIG. 7 illustrates a user interface 10. The user interface 10 includes buyer contract details 10b, which is displayed upon the buyer selecting an available contract 12a. The buyer contract details 10b includes a simulated covered outcome 60, a simulated un-covered outcome 70, and historical data 80. The simulated covered outcome 60 and the simulated un-covered outcome 70 are presented side-by-side for the buyer's ease of direct comparison. The simulated covered outcome 60 includes a total covered cost, which is a function of the settlement parameter 54, the quantity, the price limit 26b, and the premium. The simulated covered outcome 60 also displays the price limit 26b and the sum of the price limit 26b and the premium to inform the buyer on the basis of the calculation of the total covered cost. The simulated un-covered outcome 70 includes a total un-covered cost, which is a function of the quantity and the settlement parameter 54. The settlement parameter 54 is also shown in the simulated un-covered outcome 70 to inform the buyer on the basis of the calculation of the total un-covered cost. The settlement parameter 54 is selectively chosen by the buyer from a substantially continuous range 50 via a selector 52. The buyer contract details 10b further include a risk assessment 40, which details a historical occurrence assessment 42 and a projected payout 44. An adjustment of the selector 52 to any settlement parameter 54 on the substantially continuous range 50 updates, in substantially real-time, a total un-covered cost, and the risk assessment 40. The buyer contract details 10b further includes historical data 80, including a current price 82, with a line graph indicating the price limit 26b (dotted line defined by a point on the y-axis). After reviewing the information displayed on the buyer contract summary 10b, the buyer has the option to decline or purchase the contract 12a.

FIG. 8 illustrates a user interface 10. The user interface 10 includes a seller contract summary 10c, which lists available contracts 12a and pending contracts 12b. The available contracts 12a are the contracts presented to the seller can selectively view the available contracts 12a and pending contracts 12b by providing input information 20 (contract ID, raw material type, duration), which filter the contracts that will be displayed. The contract summary 10c includes contract specifications 22 and contract variables 26. The contract variables 26 include quantity, price limit, and premium. From the seller contract summary 10c, the seller may approve or decline the available contracts 12a or the buyer has the option of accessing the seller contract details (not shown) via accessing the “view contract” button.

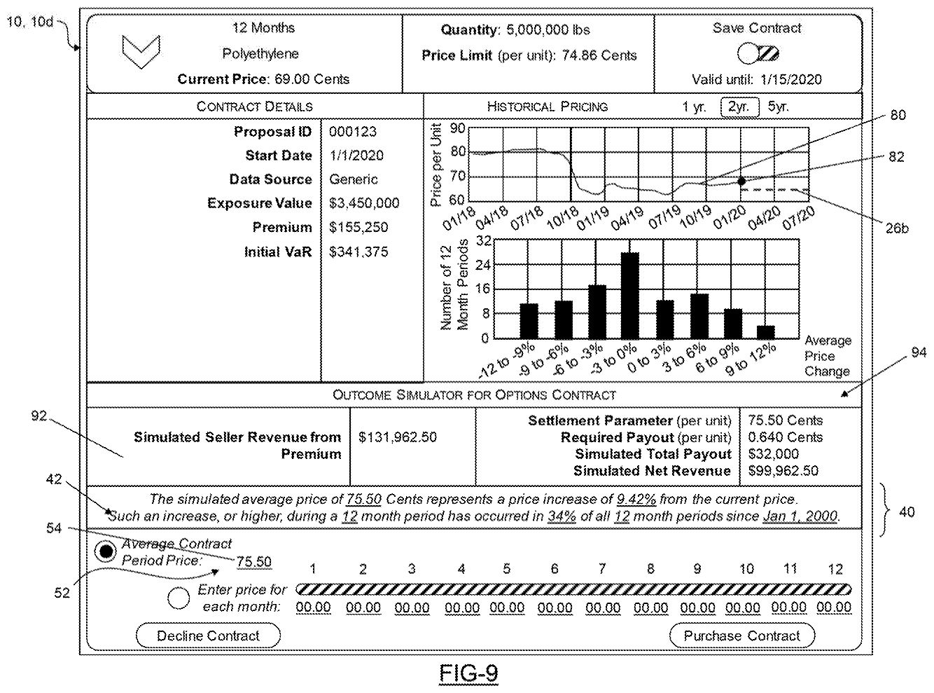

FIG. 9 illustrates a user interface 10. The user interface 10 includes seller contract details 10d, which include a simulated payout outcome 94 and historical data 80. The simulated payout outcome 94 includes a simulated seller revenue from premium 92, which is a function of quantity and premium. The simulated payout outcome 94 includes a simulated total payout and simulated net revenue. The simulated total payout is a function of the price limit 26b, the settlement parameter 54, and the quantity. The simulated net revenue is a function of the simulated seller revenue from premium, and the simulated total payout. The risk assessment 40 includes a historical occurrence assessment 42. The seller chooses a settlement parameter 54 via the selector 52 (e.g., manually entering a settlement parameter 54). The settlement parameter 54 may be manually entered as a single price for the contract duration (i.e., a financial firm may perform its own proprietary calculations for the whole duration and thereafter enter the settlement parameter) or upon prices manually entered for each month of the duration of the contract (i.e., a financial firm may perform its own proprietary calculations for each month) and a subsequent calculation of the settlement parameter. Choosing a settlement parameter 54 updates, in substantially real-time, the simulated seller revenue from premium, the simulated net revenue, and the risk assessment 40.

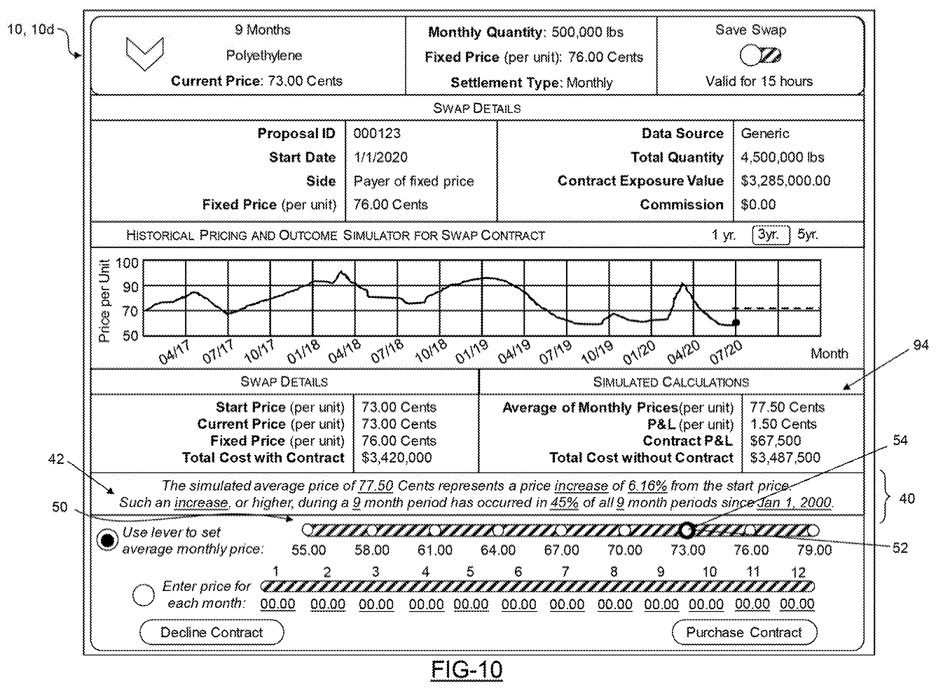

FIG. 10 illustrates a user interface 10. The user interface 10 is associated with a fixed price swap contract. The settlement parameter 54 is selectively chosen by the end user from a substantially continuous range 50 via a selector 52. Selectively choosing the settlement parameter 54 updates, in substantially real-time, the risk assessment 40, and the payout outcome 94.

### REFERENCE NUMBER LISTING

2 Customer (i.e., end-user, transacting party)
4 Financial firm (i.e., end-user, transacting party, dealer)
8 Facilitator
12 Contract (“raw material price risk mitigation contract”)
12a Available contract
12b Pending contract
10 User interface
10a Customer contract summary
10b Customer contract details
10c Financial firm contract summary
10d Financial firm contract details
11 Financial firm dashboard
12 Customer dashboard
20 Input information
22 Contract specifications
22a Raw material type
22b Duration
24 Notification dot
23 Drop-down menu
26 Contract variables
26b Price limit
26a Quantity
26c Premium
28 Widget
40 Risk assessment
42 Historical occurrence assessment
44 Projected payout
50 Substantially continuous range
52 Selector
54 Settlement parameter
60 Simulated covered outcome (i.e., processed data)
62 Total covered cost (i.e., processed data)
70 Simulated un-covered outcome (i.e., processed data)
72 Total un-covered cost (i.e., processed data)
80 Historical data (i.e., processed data)
82 Current price (i.e., processed data)
90 Simulated no-payout outcome (i.e., processed data)
92 Simulated seller revenue from premium (i.e., processed data)
94 Simulated payout outcome (i.e., processed data)
96 Simulated total payout (i.e., processed data)
98 Simulated net revenue (i.e., processed data)
100 Facilitator computer
101 End user computer
102 Processor
104 Dynamic database
106 Non-transitory computer-usable medium
108 Cache
110 Customer computer
112 Customer display
114 Browser
120 Financial firm computer
122 Financial firm display
130 Electronic network
132 Parameters
134 Data source
150 System
200 Select settlement parameter
202 Obtain processed data
206 Purchase/approve commodity contract
251 Send request for data
252 Obtain data
254 Generate processed data
256 Send processed data to end-user

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints.

The term “consisting essentially of” to describe any combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a”, “an”, and “the” include plural referents unless the context clearly dictates otherwise.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. By the term “real-time” it is meant that the event modified by the term occurs immediately antecedent to a predecessor event. For example, reciting that a contract is updated in real-time in relation to parameters, it is meant that a change to a parameter is processed by a computer, communicated via an electronic network, or both as fast as computing technology allows, which may be on the scale of milliseconds.

Features that are described, illustrated, or both with respect to one embodiment may be used in the same way or in a similar way in one or more other embodiments, in combination with or instead of the features of the other embodiments, or both.

We claim:

1. A method for mitigating raw material price risks by both a contract buyer and a contract seller through a facilitator comprising:
a) providing an end-user with access, via an electronic network, to a user interface, adapted to receive input information from the end-user, the user interface being associated with a computer of the end-user, and wherein the end-user is the contract buyer, the contract seller, or both;
b) receiving from the end-user via the electronic network, a first settlement parameter;
c) generating a first simulated covered outcome and a first simulated un-covered outcome based upon the first settlement parameter, historical data, contract specifications, and contract variables;
d) transmitting the first simulated covered outcome and the first simulated un-covered outcome to the end-user;
wherein the step of receiving the first settlement parameter and the step of generating the first simulated covered outcome and the first simulated un-covered outcome are repeated for any number of additional settlement parameters, provided by the end-user to produce any associated number of additional simulated covered outcomes and additional simulated un-covered outcomes;
wherein the user interface is adapted to graphically display a selector, the selector having a substantially continuous range of settlement parameters, and is adapted to solicit from the end-user the first settlement parameter and any of the additional settlement parameters from the substantially continuous range of settlement parameters;
wherein the step of receiving the first settlement parameter and the step of generating the first simulated covered outcome and the first simulated un-covered outcome and any number of subsequent iterations thereof are performed substantially instantaneously, with the aid of the selector, enabling the end-user to explore, visualize, and assess the raw material price risks and subsequently communicate feasible contracts to other transacting party before the first simulated covered outcome and the first simulated un-covered outcome and any number of subsequent iterations thereof are rendered moot by changes to the raw material price risks due to market forces;
wherein the other transacting party is the contract seller when the end-user is the contract buyer, and the other transacting party is the contract buyer when the end-user is the contract seller;
wherein a price risk is defined by a differential between a cost incurred by the contract buyer or by the contract seller when market prices rise or decrease above or below a defined price limit and a financial reimbursement to offset additional raw material costs incurred by the contract buyer or by the contract seller when the market prices rise or decrease above or below the defined price limit;
wherein the contract buyer or the contract seller incurs costs when the market prices rise or decrease above or below the defined price limit and the contract seller or the contract buyer guarantees payment to the other transacting party as the financial reimbursement to offset the additional raw material costs incurred by the contract buyer or the contract seller when the market prices rise or decrease above or below the defined price limit;
wherein the first settlement parameter and the additional settlement parameters are a hypothetical price of a raw material represented as a price per unit;
wherein the first simulated covered outcome and any of the additional simulated covered outcomes are a total covered cost, which is a function of a current price of the raw material, the price limit, the premium, the quantity, or any combination thereof;
wherein the first simulated un-covered outcome and any of the additional simulated un-covered outcomes are a total un-covered cost, which is a function of the first settlement parameter or the additional settlement parameters, and the quantity; and
wherein changing a position of the selector causes additional calculations to be performed with resulting simulations being graphically displayed in discrete sub-windows of a single window within the user interface.

2. The method of claim 1, wherein prior to step a, upon selecting the contract specifications, including raw material type, duration, or both, the end-user is presented with a number of automatically generated contracts having the selected contract specifications.

3. The method of claim 2, wherein each of the number of automatically generated contracts have a variety of contract variables including the price limit, a fixed price, the quantity, the premium, or any combination thereof.

4. The method of claim 3, wherein the price limit is generated on the basis of a risk analysis, the risk analysis being performed using a computer of the facilitator, based upon data from a dynamic database.

5. The method of claim 4, wherein the data from the dynamic database includes parameters that are examined and assigned a weight for use to calculate the price limit proportionate to current market conditions; and
wherein the parameters include: historical price, current price, supply and demand indicators, price of other raw materials, currency exchange rates, interest rates, other economic indicators, news directed to geopolitical events, weather data, past contract activity, or any combination thereof.

6. The method of claim 5, wherein the data from the dynamic database is updated in substantially real-time.

7. The method of claim 1, wherein the hypothetical price includes a hypothetical average price over a duration of the contract, a hypothetical last price, a hypothetical maximal price, a hypothetical minimal price, or any combination thereof.

8. The method of claim 1, wherein the simulated un-covered outcome displays a historical occurrence assessment defined by a quantity of periods on record and a quantity of periods in which the increase, decrease, or both of the market price, with respect to the price limit, occurred.

9. The method of claim 8, wherein the simulated un-covered outcome displays a projected payout defined by the simulated covered outcome and the simulated un-covered outcome.

10. The method of claim 5, wherein the historical price and the current price are determined from a price index, which is specific to a raw material type; and
wherein the dynamic database obtains price indices in substantially real-time.

11. The method of claim 1, wherein the subsequent iterations of steps enabling the end-user to explore, visualize, and assess risks and subsequently communicate feasible contracts to the other transacting party, with the aid of the selector, increases contract transparency and enables contracts to be utilized by contract buyers, contract sellers, or both for a purpose of obtaining profits therefrom or for the purpose of protecting against raw material price changes.

12. The method of claim 1, wherein ability of the end-user to explore, visualize, and assess risks and subsequently communicate feasible contracts to the other transacting party results in dissipation of fears of the end-user of being bound by contracts that will disfavor the financial position of the end-user.

13. The method of claim 1 further comprising:
a) receiving from the end-user, via the electronic network, one or more candidate contracts that exhibit feasible risk to the end-user; and
b) transmitting to the other transacting party, the one or more candidate contracts.

14-16. (canceled)

17. A computer product, comprising a non-transitory computer-usable medium having a computer-readable program code embodied therein, the computer-readable program code containing instructions that when executed by at least one processor of a computer, implements a method of mitigating raw material price risks for a contract buyer and a contract seller, wherein the method comprises:
a) obtaining from an end-user, via an electronic network, a first settlement parameter selected by the end-user through a user interface, wherein the end-user is the contract buyer, the contract seller, or both;
b) obtaining historic price data from a dynamic database and generating a graphical display of the historic price data;
c) identifying historic trigger events with respect to the first settlement parameter;
d) calculating, by the at least one processor, a first simulated covered outcome and a first simulated un-covered outcome based upon the first settlement parameter, historical data, contract specifications, and contract variables;
e) transmitting the graphical display of the historic price data, the simulated covered outcome, and the simulated un-covered outcome, via an electronic network, to the end-user;
wherein steps a through e are repeated for any number of additional settlement parameters chosen by the end-user;
wherein the user interface is adapted to graphically display a selector, the selector having a substantially continuous range of settlement parameters and solicit from the end-user the first settlement parameter and any additional settlement parameters from the substantially continuous range of settlement parameters; and
wherein steps a through e and any number of subsequent iterations thereof are performed substantially instantaneously, with the aid of the selector, enabling the end-user to explore, visualize, and assess risks and subsequently communicate feasible contracts to other transacting party before the first simulated covered outcome and the first simulated un-covered outcome and any number of subsequent iterations thereof is rendered moot by changes to the raw material due to market forces,
wherein the other transacting party is the contract seller when the end-user is the contract buyer, and the other transacting party is the contract buyer when the end-user is the contract seller;
wherein a price risk is defined by a differential between a cost incurred by the contract buyer or by the contract seller when market prices rise or decrease above or below a defined price limit and a financial reimbursement to offset additional raw material costs incurred by the contract buyer or by the contract seller when the market prices rise or decrease above or below the defined price limit;
wherein the contract buyer or the contract seller incurs costs when the market prices rise or decrease above or below the defined price limit and the contract seller or the contract buyer guarantees payment to the other transacting party as the financial reimbursement to offset the additional raw material costs incurred by the contract buyer or the contract seller when the market prices rise or decrease above or below the defined price limit;
wherein the first settlement parameter and the additional settlement parameters are a hypothetical price of a raw material represented as a price per unit;
wherein the first simulated covered outcome and any of the additional simulated covered outcomes are a total covered cost, which is a function of a current price of the raw material, the price limit, a premium, a quantity, or any combination thereof;
wherein the first simulated un-covered outcome and any of the additional simulated un-covered outcomes include a total un-covered cost, which is a function of the first settlement parameter or the additional settlement parameters, and the quantity; and
wherein changing a position of the selector causes additional calculations to be performed with resulting simulations being graphically displayed in discrete sub-windows of a single window within the user interface.

18. The method of claim 17, wherein prior to step a, upon selecting contract specifications, including raw material type, the duration, or both, the end-user is presented a number of automatically generated contracts having the selected contract specifications.

19. The method of claim 18, wherein each of the number of automatically generated contracts have a variety of contract variables including the price limit, a fixed price, the quantity, the premium, or any combination thereof.

20. The method of claim 19, wherein the price limit is generated on the basis of a risk analysis, the risk analysis being performed using a computer of the facilitator, based upon data from the dynamic database.

21. The method of claim 20, wherein the data from the dynamic database includes parameters that are examined and assigned a weight for use to calculate a price limit proportionate to current market conditions; wherein the parameters include: historical price, current price, supply and demand indicators, price of other raw materials, currency exchange rates, interest rates, other economic indicators, news directed to geopolitical events, weather data, past contract activity, or any combination thereof.

22. The method of claim 20, wherein the data from the dynamic database is updated in substantially real-time.

23-25. (canceled)

26. The method of claim 21, wherein the historical price and the current price are determined from a price index, which is specific to a raw material type; and
wherein the dynamic database obtains price indices in substantially real-time.

27-35. (canceled)
